(19) United States
(12) Patent Application Publication
(10) Pub. No.: US 2025/0242549 A1
(43) Pub. Date: Jul. 31, 2025

(54) ROTATIONALLY SYMMETRICAL PART MADE OF COMPOSITE MATERIAL HAVING AN IMPROVED HOLDING CAPACITY

(71) Applicant: SAFRAN, PARIS (FR)

(72) Inventors: Nicolas Pierre LANFANT, MOISSY-CRAMAYEL (FR); Dominique Marie Christian COUPE, MOISSY-CRAMAYEL (FR); Gurvan MOREAU, MOISSY-CRAMAYEL (FR); Enrico Giovanni OBERT, MOISSY-CRAMAYEL (FR); Nicolas HORTER, MOISSY-CRAMAYEL (FR)

(21) Appl. No.: 18/853,341

(22) PCT Filed: Apr. 6, 2023
(86) PCT No.: PCT/FR2023/050499

§ 371 Date: Oct. 1, 2024

(30) Foreign Application Priority Data
Apr. 6, 2022 (FR) FR2203153

(51) Int. Cl. B29C 70/08; B29C 70/32; B29L 31/00; B32B 1/08; B32B 5/02; B32B 5/26

(52) U.S. Cl. CPC B29C 70/081; B29C 70/32; B32B 1/08; B32B 5/022; B32B 5/024; B32B 5/265; B29L 2031/7504; B32B 2597/00

(57) ABSTRACT

A method for manufacturing a composite material revolution part for a propulsion assembly includes making a fibrous preform on a mandrel having a profile corresponding to that of the part to be manufactured, and densifying the fibrous preform by a matrix. Making the fibrous preform includes forming a strip-shaped fibrous blank including at least one layer of continuous fibers and at least one layer of discontinuous fibers, the fibrous blank being shaped on the mandrel, the layer of continuous fibers of the fibrous blank extending at least over a complete turn around the mandrel.

### TECHNICAL FIELD

The present invention relates to the general field of the manufacture of composite material revolution parts for a propulsion assembly such as gas turbine fan casings, air inlets or nacelle cowls for aeronautical engines.

### PRIOR ART

In an aeronautical gas turbine engine, the fan casing performs several functions. It defines the air inlet flowpath into the engine, supports an abradable material facing the fan blade tips, supports a possible sound wave absorption structure for the acoustic treatment at the engine inlet, and incorporates or supports a retention shield. The retention shield constitutes a debris trap retaining the debris, such as ingested objects or fragments of damaged blades, projected by centrifugation, in order to prevent them from passing through the casing and reaching other parts of the aircraft.

Previously made of metal material, the casings, such as the fan casing, are now made of composite material, i.e. from a fibrous preform densified by an organic matrix, which makes it possible to produce parts having a lower overall mass than these same parts when they are made of metal material while having at least equivalent if not greater mechanical strength.

The manufacture of a fan casing made of organic matrix composite material is described in particular in document U.S. Pat. No. 8,322,971. In the casing disclosed in document U.S. Pat. No. 8,322,971, the retention shield is constituted by an excess thickness portion obtained at the level of the fibrous reinforcement of the casing which has a variable thickness. The fibrous reinforcement is obtained by winding a 3D-woven fibrous texture which has an excess thickness portion able to form a retention shield.

However, in order to be able to contain debris projected with very high energy as in the case of the loss of a blade, the excess thickness portion must always have a significant dimension in the radial direction, which significantly increases the overall mass of the composite material part. The same applies for an air inlet or a nacelle cowl of a propulsion assembly.

### DISCLOSURE OF THE INVENTION

It is therefore desirable to be able to have a solution for providing a composite material revolution part for a propulsion assembly having an overall mass lower than that of the composite material casings of the prior art while having an at least equivalent if not higher retention capacity.

To this end, according to the invention, a method is proposed for manufacturing a composite material revolution part for a propulsion assembly comprising:
making a fibrous preform on a mandrel having a profile corresponding to that of the part to be manufactured, and
densifying the fibrous preform by a matrix,
characterized in that making the fibrous preform comprises forming a strip-shaped fibrous blank comprising at least one layer of continuous fibers and at least one layer of discontinuous fibers, the fibrous blank being shaped on the mandrel, said at least one layer of continuous fibers of the fibrous blank extending at least over a complete turn around the mandrel.

The method of the invention thus makes it possible to obtain a composite material part having an increased retention capacity thanks to the presence of one or several layers of discontinuous fibers in its fibrous reinforcement. The layer(s) of discontinuous fibers are indeed able to be damaged to dissipate energy in case of impact with a projected object such as a blade in the case of an aeronautical engine casing (FBO for Fan Blade Out). The layer(s) of continuous fibers for their part ensure the mechanical cohesion and strength of the part.

It is thus possible to manufacture composite material revolution parts having a very good retention capacity without requiring a too significant increase in thickness, the parts having an overall mass lower than that of the composite material parts of the prior art.

According to one aspect of the method of the invention, the layer(s) of discontinuous fibers are a non-woven texture with discontinuous long fibers or a mat of random fibers.

According to another aspect of the method of the invention, the layer(s) of continuous fibers are chosen from at least one of the following fibrous structures: three-dimensional woven structure, stack of unidirectional plies, stack of two-dimensional woven plies, braid. The fibrous blank can comprise a single layer of continuous fibers corresponding to a strip-shaped fibrous structure having a three-dimensional weaving between a plurality of warp yarns and a plurality of weft yarns. In this case, making the fibrous preform comprises winding the fibrous blank on the mandrel over one or several turns. The fibrous blank can comprise a single layer of continuous fibers also corresponding to a strip-shaped fibrous structure having a three-dimensional weaving which includes, in the length direction, a first portion in which the warp yarns are interlinked by the weft yarns over the entire thickness of the fibrous structure and a second portion comprising a non-interlinked area present at an intermediate position in the thickness of the fibrous structure and extending in the fibrous structure along a plane parallel to the surface of the fibrous structure, the non-interlinked area separating the fibrous structure into first and second skins, the layer of discontinuous fibers being disposed between the first and second skins. In this case, making the fibrous structure comprises winding the fibrous blank on the mandrel over one or several turns.

The invention also relates to a composite material revolution part for a propulsion assembly comprising a fibrous reinforcement, said fibrous reinforcement being densified by a matrix, characterized in that the fibrous reinforcement comprises, in the thickness direction, at least one layer of continuous fibers and at least one layer of discontinuous fibers.

As explained above, the composite material part of the invention offers a very good retention capacity while having a controlled thickness and, consequently, a reduced overall mass compared to that of the composite material parts of the prior art.

According to one aspect of the part of the invention, the layer(s) of discontinuous fibers are a non-woven texture with discontinuous long fibers or a mat of random fibers.

According to another aspect of the part of the invention, the layer(s) of continuous fibers are chosen from at least one of the following fibrous structures: three-dimensional woven structure, stack of unidirectional plies, stack of two-dimensional woven plies, braid. The fibrous reinforcement can comprise a single layer of continuous fibers consisting of a strip-shaped fibrous structure having a three-dimensional or multi-layer weaving including a first portion in which warp yarns are interlinked by weft yarns over the entire thickness of the fibrous structure and a second portion comprising a non-interlinked area present at an intermediate position in the thickness of the fibrous structure, the non-interlinked area separating the fibrous structure into first and second skins, the layer of discontinuous fibers being present between the first and second skins.

According to another aspect of the part of the invention, the latter corresponds to a casing comprising a shroud including an excess thickness portion forming a retention area, the shroud further including a clamp at its axial ends.

### BRIEF DESCRIPTION OF THE DRAWINGS

FIG. 1 is a perspective and partial sectional view of an aeronautical engine equipped with a fan casing made of composite material in accordance with one embodiment of the invention,

FIG. 2 is a sectional view along the plane II-II of the casing of FIG. 1,

FIG. 3 is a schematic perspective view of a loom showing the weaving of a fibrous texture used for the formation of the fibrous reinforcement of the casing of FIGS. 1 and 2,

FIG. 4 is a schematic perspective view of a layer with continuous fibers,

FIG. 5 is a schematic perspective view of a layer with discontinuous fibers,

FIG. 6 is a schematic perspective view of a fibrous blank formed with the layers of FIGS. 4 and 5 in accordance with one embodiment of the invention,

FIG. 7 is a schematic perspective view showing the shaping of the fibrous blank of FIG. 6,

FIG. 8 is a sectional view of a fibrous preform obtained from the fibrous blank of FIG. 6,

FIG. 9 is a schematic view showing a tooling for densifying the preform of FIG. 8,

FIG. 10 is a schematic perspective view showing the formation of a fibrous blank in accordance with another embodiment of the invention,

FIG. 11 is a sectional view of a casing made from the fibrous blank of FIG. 10.

### DESCRIPTION OF THE EMBODIMENTS

The invention generally applies to any composite material revolution part for a propulsion assembly, the revolution part being likely to be exposed to impacts. Such parts for propulsion assembly relate in particular, but not exclusively, to gas turbine fan casings, nacelle air inlets and nacelle cowls present in aeronautical engines.

The invention will be described below in the context of its application to a fan casing of an aeronautical gas turbine engine.

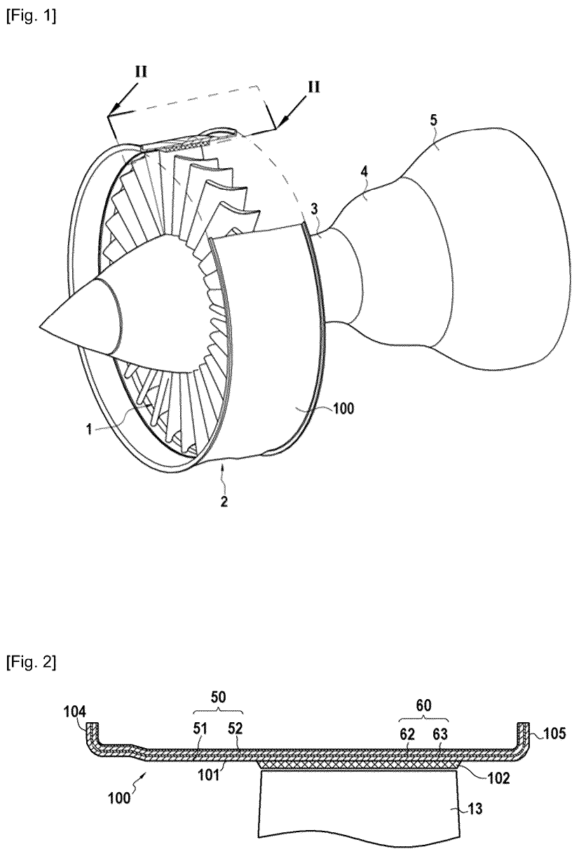

Such an engine, as shown very schematically in FIG. 1, comprises, from upstream to downstream in the direction of the gas stream flow, a fan 1 disposed at the engine inlet, a compressor 2, a combustion chamber 3, a high-pressure turbine 4 and a low-pressure turbine 5.

The engine is housed inside a casing comprising several portions corresponding to different elements of the engine. Thus, the fan 1 is surrounded by a fan casing 100.

FIG. 2 shows a profile of a fan casing 100 made of composite material as it can be obtained by a method according to the invention. The inner surface 101 of the casing defines the air inlet flowpath. It can be provided with a layer of abradable coating 102 in line with the trajectory of the fan blade tips, a blade 13 being partially shown very schematically. The abradable coating is therefore disposed on only part of the length (in the axial direction) of the casing. An acoustic treatment coating (not represented) can further be disposed on the inner surface 101 in particular upstream of the abradable coating 102.

The casing 100 can be provided with outer clamps 104, 105 at its upstream and downstream ends in order to allow its mounting and its connection with other elements.

The casing 100 is made of composite material with fibrous reinforcement densified by a matrix. The reinforcement is made of fibers, for example carbon, glass, aramid or ceramic fibers, and the matrix is made of polymer, for example epoxy, bismaleimide or polyimide, of carbon or of ceramic.

In the example described here, the fibrous reinforcement is formed by winding a fibrous blank on a mandrel, the mandrel having a profile corresponding to that of the casing to be made. Advantageously, the fibrous reinforcement constitutes a complete tubular fibrous preform of the casing 100 forming a single piece with reinforcement portions corresponding to the clamps 104, 105.

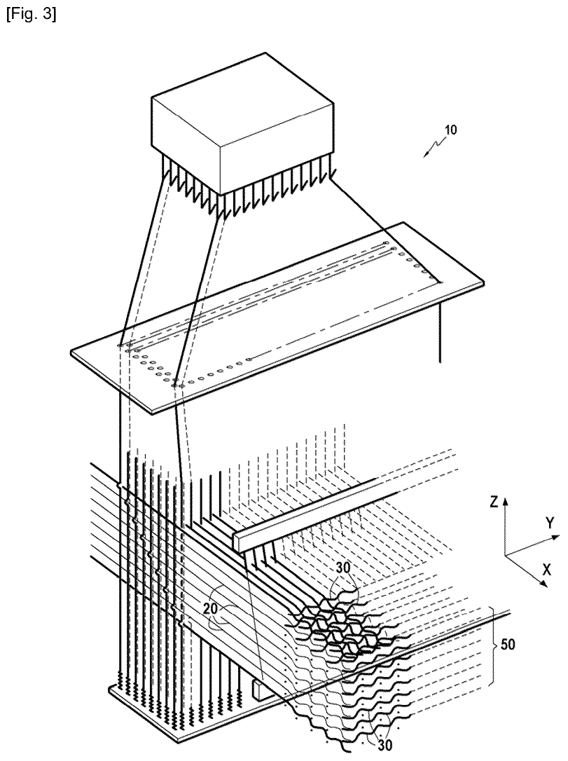

In accordance with the invention, the fibrous blank is made up of at least one layer of continuous fibers and at least one layer of discontinuous fibers assembled together as described below. In the example described here, the layer of continuous fibers is made up of a strip-shaped fibrous structure having a three-dimensional weaving. More specifically and as illustrated in FIG. 3, a fibrous structure 50 is made in a known manner by three-dimensional weaving using a jacquard-type loom 10 on which a bundle of warp yarns or strands 20 has been disposed in a plurality of layers, the warp yarns being interlinked by weft yarns or strands 30. The yarns used for the weaving of the fibrous structure 50 are, for example, yarns made of carbon fibers, for example HexTow®IM7, HexTow®AS4 or HexTow®AS7 fibers, or ceramic fibers such as silicon carbide, glass fibers, or aramid fibers. The yarn count is typically 12k, 24k or 48k. Different types of yarns can be used within the same preform. The fibrous structure is made by three-dimensional weaving. By “three-dimensional weaving” or “3D weaving” is meant here a weaving mode by which some at least of the weft yarns interlink warp yarns on several layers of warp yarns or vice versa. One example of three-dimensional weaving is the weaving called “interlock” weave. By “interlock” weaving is meant here a weave in which each layer of warp yarns interlinks several layers of weft yarns with all the yarns of the same warp column having the same movement in the weave plane.

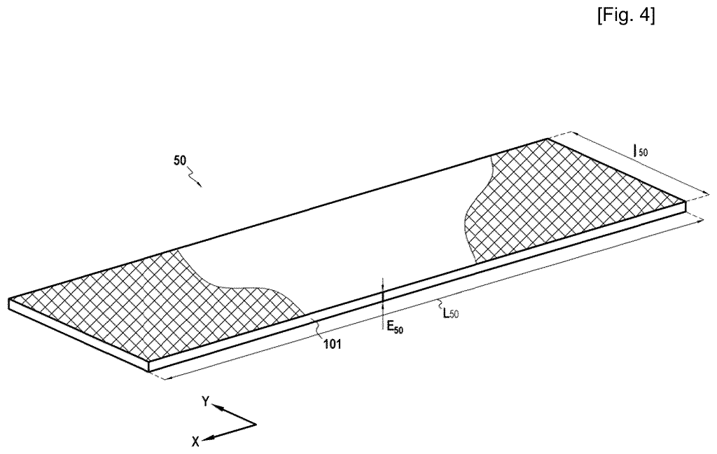

As illustrated in FIGS. 3 and 4, the fibrous structure 50 has a strip shape that extends in length in a direction X corresponding to the direction of travel of the warp yarns or strands 20 and in width or transversely in a direction Y corresponding to the direction of the weft yarns or strands 30.

As illustrated in FIG. 4, the fibrous structure 50 has a strip shape with a thickness E₅₀, for example 5 mm, corresponding to a 3D weaving with between three and five warp layers woven together in the plane and in the thickness of the strip using weft yarns. The fibrous structure 50 extending over a width I₅₀ defined as a function of the width of the casing to be manufactured, the width I₅₀ being able to be for example 2 m, and over a length L₅₀ defined as a function of the diameter of the casing to be manufactured and of the desired number of turns in the fibrous reinforcement. For example, to manufacture a cylindrical similar casing with a diameter of 4 m by making 2 blank turns, the length of the fibrous structure to be woven is approximately 25 m. The length can be extended to prevent the start and end of the fibrous structure from being at the same angular position, which could create a weakness in the part.

In the example described here, the layer of discontinuous fibers consists of a fiber mat. By “fiber mat” is meant a fibrous texture corresponding to an agglomerate of discontinuous fibers, the fibers generally being disposed randomly or in bulk so as to obtain isotropic behavior in the plane. In the invention, the production of the fiber mat can be adapted so as to obtain a mat with orthotropic properties making it possible to have modules in the plane as close as possible to the modules in the warp direction and/or in the weft direction of the 3D-woven fibrous structure which can be different. In this case, the percentage of fibers in the direction of the sheet and the transverse direction can be influenced by the speed of advance of the conveyor system. The faster the advance, the more the fibers are statistically oriented in the direction of the roller. It is also possible to define drop shafts which reorient more or less the fibers.

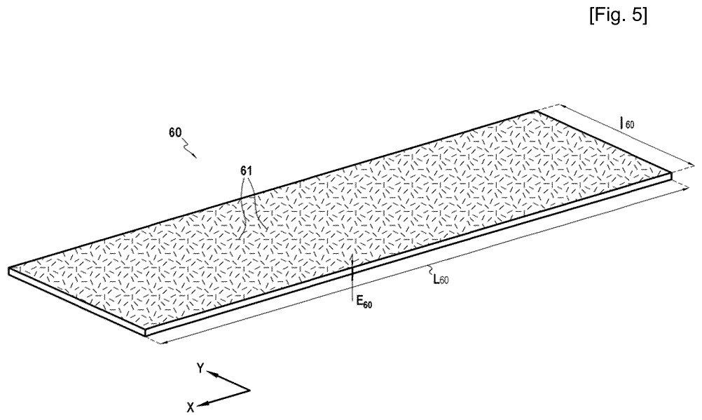

FIG. 5 illustrates a strip-shaped fiber mat 60 comprising fibers 61 randomly distributed over a thickness E₆₀ comprised preferably between 1 mm and 5 mm. In the example described here, the fiber mat 60 has a width I₆₀ equivalent to the width 150 of the fibrous structure 50 and a length L₆₀ smaller than the length L₅₀ of the fibrous structure 50 so that only the fibrous structure 50 is present in the last winding turn of the fibrous blank. The fiber mat 60 preferably includes the same type of fibers as the fibrous structure 50. The grammage of the fiber mat is typically comprised between 200 g/m² and 1,000 g/m² even if higher grammages can be used.

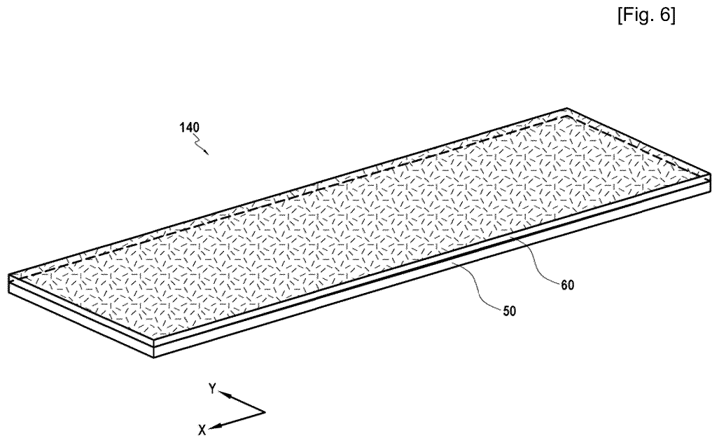

A fibrous blank 140 is then made by arranging the fiber mat 60 on the 3D-woven fibrous structure 50 as illustrated in FIG. 6. A step of stitching the assembly edges between the fiber mat 60 and the fibrous structure 50 can also be carried out in order to hold them in position in the fibrous blank 140. The fibrous blank 140 can be compacted in order to reduce the expansion before it is winding.

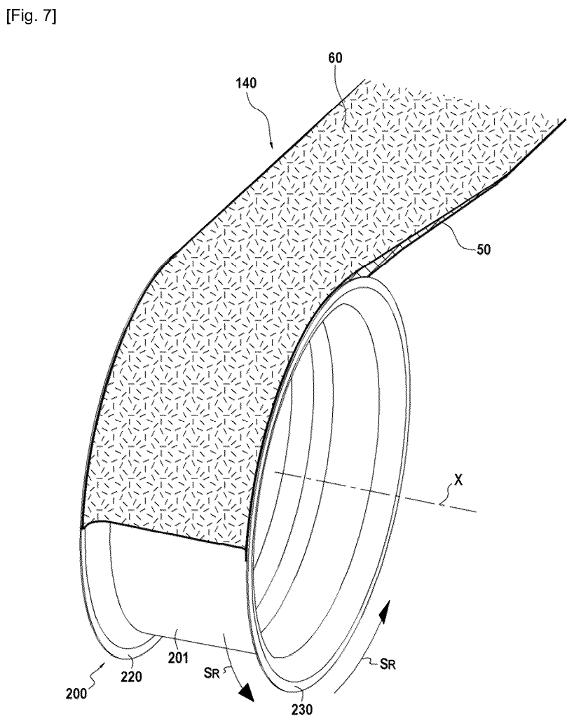

As illustrated in FIG. 7, a fibrous preform is then formed by winding the fibrous blank 140 along a direction S_{R} on a mandrel 200 with the fibrous structure 50 disposed against the mandrel 200, the mandrel having a profile corresponding to that of the casing to be made. The mandrel 200 has an outer surface 201 whose profile corresponds to the inner surface of the casing to be made. By being wound on the mandrel 200, the fibrous blank 140 matches the profile thereof. The mandrel 200 also includes two flanges 220 and 230 to form fibrous preform portions corresponding to the clamps 104 and 105 of the casing 100.

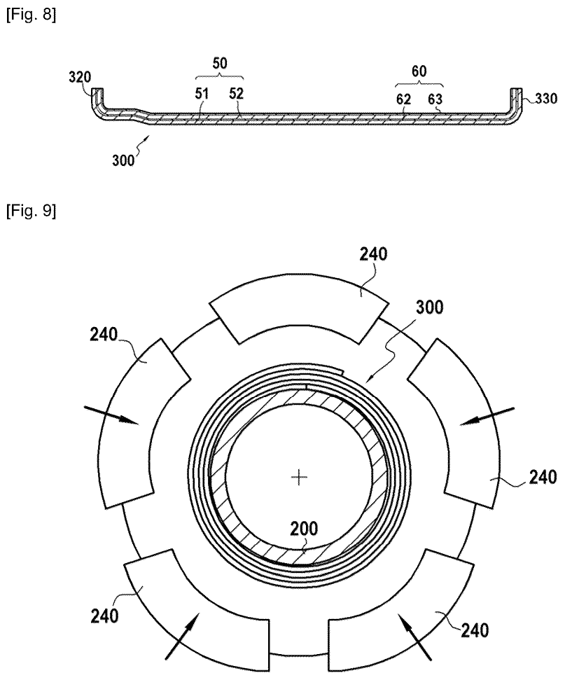

FIG. 8 shows a sectional view of the fibrous preform 300 obtained after winding of the fibrous blank 140 in several layers on the mandrel 200. The number of turns or coils is a function of the desired thickness and of the thickness of the fibrous texture. It is preferably at least equal to 2. In the example described here, the preform 300 comprises, along the direction of its thickness, two layers 51 and 52 of fibrous structure 50 and two layers 62 and 63 of fiber mat 60, the layer 62 being interposed between the adjacent layers 51 and 52 while the layer 63 is present on the outer periphery of the preform 300. The fibrous preform 300 also comprises end portions 320, 330 corresponding to the clamps 104, 105 of the casing.

The fibrous preform 300 is then densified by a matrix.

The densification of the fibrous preform consists in filling the porosity of the preform, in all or part of the volume thereof, with the material constituting the matrix.

The matrix can be obtained in a manner known per se according to the liquid process method.

The liquid process method consists in impregnating the preform with a liquid composition containing an organic precursor of the matrix material. The organic precursor is usually in the form of a polymer, such as a resin, optionally diluted in a solvent. The fibrous preform is placed in a mold that can be closed in a sealed manner with a housing having the shape of the final molded part. As illustrated in FIG. 9, the fibrous preform 300 is here placed between a plurality of sectors 240 forming a counter-mold and the mandrel 200 forming a support, these elements having respectively the external shape and the internal shape of the casing to be made. Then, the liquid matrix precursor, for example a resin, is injected into the entire housing to impregnate the entire fibrous portion of the preform.

The transformation of the precursor into organic matrix, namely its polymerization, is carried out by heat treatment, generally by heating of the mold, after removal of any solvent and crosslinking of the polymer, the preform still being maintained in the mold having a shape corresponding to that of the part to be made. The organic matrix can be obtained in particular from epoxy resins, such as, for example, the high-performance epoxy resin sold, or from liquid precursors of carbon or ceramic matrices.

In the case of formation of a carbon or ceramic matrix, the heat treatment consists in pyrolyzing the organic precursor to transform the organic matrix into a carbon or ceramic matrix depending on the precursor used and the pyrolysis conditions. For example, liquid carbon precursors can be resins with a relatively high coke content, such as phenolic resins, while liquid ceramic precursors, in particular SiC, can be resins of the polycarbosilane (PCS) or polytitanocarbosilane (PTCS) or polysilazane (PSZ) type. Several consecutive cycles, from impregnation to heat treatment, can be carried out to achieve the desired degree of densification.

According to one aspect of the invention, the densification of the fibrous preform can be carried out by the well-known transfer molding process called RTM (Resin Transfer Molding). According to the RTM process, the fibrous preform is placed in a mold having the shape of the casing to be made. A thermosetting resin is injected into the internal space delimited between the mandrel 200 and the counter-molds 240.

The resin used can be, for example, an epoxy resin. Resins suitable for RTM processes are well known. They preferably have a low viscosity to facilitate their injection into the fibers. The choice of the temperature class and/or the chemical nature of the resin is determined according to the thermomechanical loads to which the part must be subjected. Once the resin has been injected throughout the reinforcement, it is polymerized by heat treatment in accordance with the RTM process.

After injection and polymerization, the part is demolded. Finally, the part is trimmed to remove excess resin and the chamfers are machined to obtain the casing 100 illustrated in FIGS. 1 and 2. The casing 100 made of composite material thus comprises a fibrous reinforcement consisting, in the direction of its thickness, of two layers 51 and 52 of fibrous structure 50 and two layers 62 and 63 of fiber mat 60, the layer 62 being interposed between the adjacent layers 51 and 52 while the layer 63 is present on the external periphery of the casing 100. The number of turns or coils of continuous fiber layers (here the fibrous structure 50) is a function of the desired thickness and of the thickness of the layer. It is preferably at least equal to 2. The number of turns or coils of discontinuous fiber layers (here the fiber mat 60) is a function of the desired retention capacity. The casing 100 thus has over its entire width a retention area or shield capable of retaining debris, particles or objects ingested at the engine inlet, or originating from the damage to the fan blades, and projected radially by rotation of the fan, to prevent them from passing through the casing and damaging other portions of the aircraft. The layer of discontinuous fibers constituted here by the fiber mat 60 can have a width smaller than that of the layer of continuous fibers constituted here by the fibrous structure 50. In this case, the layer of discontinuous fibers forms an excess thickness in the casing as described below corresponding to the retention area or shield of the casing.

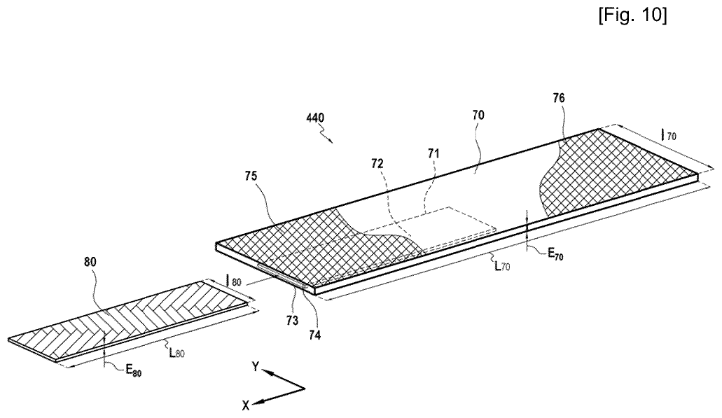

FIG. 10 illustrates the formation of a fibrous blank 440 according to another embodiment of the invention. The fibrous blank 440 is formed by the assembly of a layer of continuous fibers with a layer of discontinuous fibers. More specifically and as illustrated in FIG. 10, a fibrous structure 70 is made in a known manner by 3D weaving with, for example, yarns made of carbon fibers, for example HexTow® IM7, HexTow® AS4 or HexTow® AS7 fibers, or ceramic fibers such as silicon carbide, glass fibers, or aramid fibers. The yarn count is typically 12k, 24k or 48k. Different types of yarns can be used within the same preform.

As illustrated in FIG. 10, the fibrous structure 70 has a strip shape that extends in length in a direction X corresponding to the direction of travel of the warp yarns or strands and in width or transversely in a direction Y corresponding to the direction of the weft yarns or strands. The fibrous structure 70 has a strip shape with a thickness E₇₀, for example 10 mm corresponding to a 3D weaving with between six and ten warp layers woven together in the plane and in the thickness of the strip using weft yarns. The fibrous structure 70 extending over a width I₇₀ defined as a function of the width of the casing to be manufactured, the width I₇₀ being able to be for example 2 m, and over a length Lo defined as a function of the diameter of the casing to be manufactured and on the desired number of turns in the fibrous reinforcement. For example, to manufacture a similar cylindrical casing with a diameter of 4 m by making 2 preform turns, the length of the fibrous structure to be woven is approximately 25 m. The length can be extended in order to prevent the start and the end of the fibrous structure from being at the same angular position, which could create a weakness in the part.

The fibrous blank 440 further comprises a layer of discontinuous fibers. In the example described here, the layer of discontinuous fibers is constituted by a non-woven texture with discontinuous long fibers 80 (DLF). The discontinuous long fibers have a length comprised between 8 mm and 100 mm, for example 12.5, 25 or 50 mm.

In the example described here, the non-woven texture with discontinuous long fibers 80 has dimensions smaller than the fibrous structure 70 so as to form an excess thickness portion in the final casing as described below. Thus, the texture 80 has a strip shape with a width I₈₀ smaller than the width I₇₀ of the fibrous structure 70 and a corresponding length L₈₀ smaller than or equal to half the length L₇₀ of the fibrous structure 70 so that only the fibrous structure 70 is present in the first or last winding turn of the fibrous blank depending on the winding arrangement of the blank on the mandrel. The texture 80 has a thickness E₈₀ comprised preferably between 1 mm and 5 mm. The texture 80 preferably includes the same type of fibers as the fibrous structure 70. The fibrous texture 80 is preferably compacted before its insertion into the structure 70. The fibrous structure 70 can also be compacted in order to facilitate the insertion of the texture 80.

The fibrous blank 440 further differs from the fibrous blank 140 described above in that the non-woven texture with discontinuous long fibers 80 is inserted into a non-interlinked portion of the fibrous structure 70. More specifically, the fibrous structure 70 comprises a first portion 75 including an inner non-interlinked area 71 and a second portion 76 without non-interlinking. The first portion 75 can for example have a length of 12 m while the second portion can have a length of 13 m. In this case, the non-woven texture with discontinuous long fibers 80 has a length less than or equal to 12 m. The non-interlinking area 71 locally forms in the fibrous structure 70 first and second superimposed skins 73 and 74 and separated from each other along a plane parallel to the surface of the fibrous structure 70 so as to delimit therebetween an inner housing 72. In a known manner, the non-interlinking area 71 is obtained by defining a plane parallel to the surface of the fibrous structure 70 and typically located at half the thickness E₇₀ of the structure 70 which is not crossed by weft yarns. More specifically, in the example described here, the weft yarns present in the first skin 73 do not extend into the layers of warp yarns of the second skin 74 while the weft yarns present in the second skin 74 do not extend into the layers of warp yarns of the first skin 73 in order to form the non-interlinking area 71. The skins 73 and 74 each include, for example, three to five warp layers woven together in the plane and in the thickness of the strip using weft yarns. The skins can of course include a different number of warp layers.

Still in the example described here, the non-interlinking area does not extend to the lateral edges of the fibrous structure thus forming a “sock”-shaped housing. The non-interlinking area can however extend to the lateral edges of the fibrous structure, thus separating the fibrous structure into two skins over the entire width thereof.

The fibrous blank 440 is formed by insertion of the non-woven texture with discontinuous long fibers 80 into the housing 72 of the fibrous structure 70 as illustrated in FIG. 10.

A fibrous preform is then formed by winding the fibrous blank 440 on a mandrel as for the fibrous blank 140 of FIG. 7.

The winding on the mandrel can begin with the first portion 75 or the second portion 76 of the fibrous structure 70 depending on the stacking order desired to be obtained in the thickness direction (namely first skin 73, texture 80, second skin 74 and second portion 76 or second portion 76, first skin 73, texture 80 and second skin 74). In the example described here, it is the first portion 75 of the fibrous structure 70 that is wound first on the mandrel.

Then the fibrous preform is densified by a matrix according to the conditions already described previously for the fibrous preform 300.

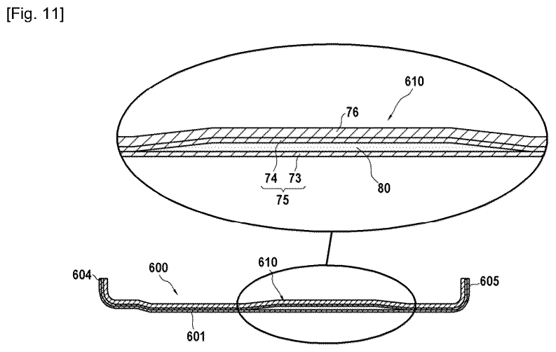

After injection and polymerization, the part is demolded. Finally, the part is trimmed to remove excess resin and the chamfers are machined to obtain a casing 600 illustrated in FIG. 11. The inner surface 601 of the casing defines the air inlet flowpath. It can be provided with a layer of abradable coating and/or with an acoustic treatment coating (not represented in FIG. 11). The casing 600 here has outer clamps 604, 605 at its upstream and downstream ends in order to allow its mounting and its connection with other elements.

The composite material casing 600 thus comprises a fibrous reinforcement consisting, between its inner periphery and its outer periphery, of the first skin 73 of the first portion 75 of the fibrous structure 70, of the non-woven texture with discontinuous long fibers 80, of the second skin 74 of the first portion 75 of the fibrous structure 70 and of the second portion 76 of the fibrous structure 70. The number of turns or coils of layers of continuous fibers (here the fibrous structure 70) is a function of the desired thickness and of the thickness of the layer. It is preferably at least equal to 2. The number of turns or coils of layers of discontinuous fibers (here the non-woven texture with discontinuous long fibers 80) is a function of the desired retention capacity.

In the example described here, the casing 600 further includes an extra thickness portion 610 formed by the insertion of the non-woven texture with discontinuous long fibers 80 into the fibrous structure 70. This extra thickness portion forms a retention area or shield capable of retaining debris, particles or objects ingested at the engine inlet, or originating from the damage to fan blades, and projected radially by rotation of the fan, to prevent them from passing through the casing and damaging other portions of the aircraft.

The presence of a layer of discontinuous fibers over the entire width of the part (casing 100) or over a portion of the width of the part (casing 600) makes it possible to give the part a very good retention capacity.

In the examples described above, the layer of continuous fibers is a strip having a 3D weaving. The layer of continuous fibers can also be a stack of unidirectional plies, a stack of two-dimensional woven plies, or a braid.

The layer of discontinuous fibers can be in particular a non-woven texture with discontinuous long fibers or a mat of random fibers.

The manufacturing method described above in relation to a fan casing of an aeronautical gas turbine engine also applies to the manufacture of other composite material revolution parts for a propulsion assembly such as nacelle or nacelle cowl air inlets.

1. A method for manufacturing a composite material revolution part for a propulsion assembly comprising:
making a fibrous preform on a mandrel having a profile corresponding to that of the part to be manufactured, and
densifying the fibrous preform by a matrix,
wherein making the fibrous preform comprises forming a strip-shaped fibrous blank comprising at least one layer of continuous fibers and at least one layer of discontinuous fibers, the fibrous blank being shaped on the mandrel, said at least one layer of continuous fibers of the fibrous blank extending at least over a complete turn around the mandrel.

2. The method according to claim 1, wherein said at least one layer of discontinuous fibers is a non-woven texture with discontinuous long fibers or a mat of random fibers.

3. The method according to claim 1, wherein said at least one layer of continuous fibers is chosen from at least one of the following fibrous structures: three-dimensional woven structure, stack of unidirectional plies, stack of two-dimensional woven plies, braid.

4. The method according to claim 3, wherein the fibrous blank comprises a layer of continuous fibers corresponding to a strip-shaped fibrous structure having a three-dimensional weaving between a plurality of warp yarns and a plurality of weft yarns and wherein making the fibrous preform comprises winding the fibrous blank on the mandrel over one or several turns.

5. The method according to claim 3, wherein the fibrous blank comprises a layer of continuous fibers corresponding to a strip-shaped fibrous structure having a three-dimensional weaving including, in the length direction, a first portion in which the warp yarns are interlinked by the weft yarns over the entire thickness of the fibrous structure and a second portion comprising a non-interlinked area present at an intermediate position in the thickness of the fibrous structure and extending in the fibrous structure along a plane parallel to the surface of the fibrous structure, the non-interlinked area separating the fibrous structure into first and second skins, a layer of discontinuous fibers being disposed between the first and second skins, and wherein making the fibrous structure comprises winding the fibrous blank on the mandrel over one or several turns.

6. A composite material revolution part for a propulsion assembly comprising a fibrous reinforcement, said fibrous reinforcement being densified by a matrix, wherein the fibrous reinforcement comprises, in the thickness direction, at least one layer of continuous fibers and at least one layer of discontinuous fibers.

7. A part according to claim 6, wherein said at least one layer of discontinuous fibers is a non-woven texture with discontinuous long fibers or a mat of random fibers.

8. The part according to claim 6, wherein said at least one layer of continuous fibers is chosen from at least one of the following fibrous structures: three-dimensional woven structure, stack of unidirectional plies, stack of two-dimensional woven plies, braid.

9. The part according to claim 8, wherein the fibrous reinforcement comprises a layer of continuous fibers corresponding to a strip-shaped fibrous structure having a three-dimensional or multi-layer weaving including a first portion in which warp yarns are interlinked by weft yarns over the entire thickness of the fibrous structure and a second portion comprising a non-interlinked area present at an intermediate position in the thickness of the fibrous structure, the non-interlinked area separating the fibrous structure into first and second skins, the layer of discontinuous fibers being present between the first and second skins.

10. The part according to claim 6, the part corresponding to a casing comprising a shroud including an excess thickness portion forming a retention area, the shroud further including a clamp at its axial ends.
